(19) United States
(12) Patent Application Publication
(10) Pub. No.: US 2006/0196327 A1
(43) Pub. Date: Sep. 7, 2006

(54) One-step method and means for cutting and embossing die cuts

(76) Inventor: Consuelo N. Larsen, Highland, UT (US)

Correspondence Address: KUNZLER & ASSOCIATES, 8 EAST BROADWAY, SUITE 600, SALT LAKE CITY, UT, 84111, US

(21) Appl. No.: 11/092,151

(22) Filed: Mar. 29, 2005

Related U.S. Application Data
(60) Provisional application No. 60/658,322, filed on Mar. 3, 2005.

(51) Int. Cl. B26D 1/00

(52) U.S. Cl. 83/13

(57) ABSTRACT

A one-step method and means for cutting and embossing die cuts comprising first and second die plates which are movable towards one another. Each of the first and second die plates includes first and second sides. The second side of the first die plate has a cutting land projecting therefrom and also has an embossing land projecting therefrom within the cutting land. The second side of the second die plate has an embossing recess formed therein which registers with the embossing land. When a sheet of paper stock or card stock is positioned between the first and second die plates and the die plates are moved towards one another, the cutting land cuts a die cut from the paper stock or card stock while the embossing land embosses the die cut. The cutting and embossing is achieved in a single step.

### CROSS-REFERENCE TO RELATED APPLICATION

This application claims the benefit of U.S. Provisional Application Ser. No. 60/658,322 entitled ONE-STEP METHOD AND MEANS FOR CUTTING AND EMBOSSING DIE CUTS filed Mar. 3, 2005, the disclosure of which is hereby incorporated herein by reference.

### BACKGROUND OF THE INVENTION

1. Field of the Invention

This invention relates to a one-step method and means for cutting and embossing die cuts. More particularly, the invention relates to a one-step method and means for cutting and embossing die cuts which are used in the scrap booking and paper crafting arts.

2. Description of the Related Art

In the scrapbooking and paper crafting art, die cutting machines are used to create die cuts from paper stock or card stock with the die cuts being used to decorate or embellish cards, scrapbooks, etc. Normally, a sheet of paper or card stock is placed over a die, the configuration is then placed in a die cutting machine which creates a shape or design from a sheet of paper or card stock. After the design has been cut and separated from the paper stock or card stock, if the die cut is to be embossed, it is necessary to perform the embossing step. In other words, the cutting and embossing of die cuts is a two-step process. One method of performing the embossing step is to manually move a burnishing tool over the separated die cut which has been positioned in an embossing stencil.

### SUMMARY OF THE INVENTION

A one-step method and means for cutting and embossing die cuts is described. The means for cutting and embossing the die cuts comprises a first male die plate having a first side, a second side and a hinge edge and a second female die plate having a first side, a second side and a hinge edge. The first sides of the first and second die plates are preferably substantially flat. The second side of the first die plate has a cutting land projecting therefrom which is adapted to cut through or substantially cut through a piece of paper or card stock to create a die cut which is separable from the paper stock or card stock. The second side of the first die plate also has at least one embossing land projecting therefrom inwardly of the cutting land for embossing the die cut. The second side of the second die plate has at least one recessed cavity formed therein which is complementary in size and shape to the said at least one embossing land projecting from the second side of the first die plate. The hinge edges of the first and second die plates are hingedly secured together so that the die plates may be opened to permit the paper stock or card stock therebetween and which may be moved to a closed position wherein the second sides of the die plates face one another. The hinge connection of the die plates maintains the cutting land in the proper position and maintains the at least one embossing land on the first die plate in register with the at least one recessed cavity formed in the second die plate. When a sheet of paper stock or card stock is placed between the first and second die plates and pressure is applied thereto, the cutting land on the first die plate separates or substantially separates a die cut from the paper stock or card stock and the embossing land embosses the die cut.

The cutting land and the embossing land on the first die plate and the recessed area on the second die plate are created by chemical etching, chemical milling or mechanical etching. Thus, the die plates of this invention enable a die cut to be cut from paper stock or card stock with the die cut also being embossed in a single cutting and embossing operation.

It is therefore a principal object of the invention to provide a one-step method and means for cutting and embossing die cuts.

Still another object of the invention is to provide a cutting and embossing die plate assembly.

Still another object of the invention is to provide a cutting and embossing die plate assembly which is comprised of first and second die plates with the cutting land, embossing land and recessed areas on the die plates being created by chemical etching, chemical milling and/or mechanical etching.

A further object of the invention is to provide a one-step method and means for cutting and embossing die cuts which greatly reduces the time consumed which is normally required for cutting and embossing die cuts.

Yet another object of the invention is to provide a means for cutting and embossing die cuts including a pair of hingedly connected together die plates with the die plates being able to be passed through die cutting machines.

These and other objects will be apparent to those skilled in the art.

### BRIEF DESCRIPTION OF THE DRAWINGS

FIG. 1 is an end view of the die plates of this invention prior to the die plates being chemically etched, chemically milled or mechanically etched;

FIG. 2 is a sectional view of the die plates of FIG. 1 after they have been chemically etched;

FIG. 3 is a schematic view illustrating the manner in which the die plates cooperate to perform die cuts;

FIG. 4 is an end view of the die plate assembly of this invention having a piece of paper or card stock placed on the male die plate with the broken lines illustrating the position wherein the female die plate is in its closed position;

FIG. 5 is a plan view of a typical die cut which is created by the die plate assembly of this invention; and

FIG. 6 is a sectional view as seen on lines 6-6 of FIG. 5.

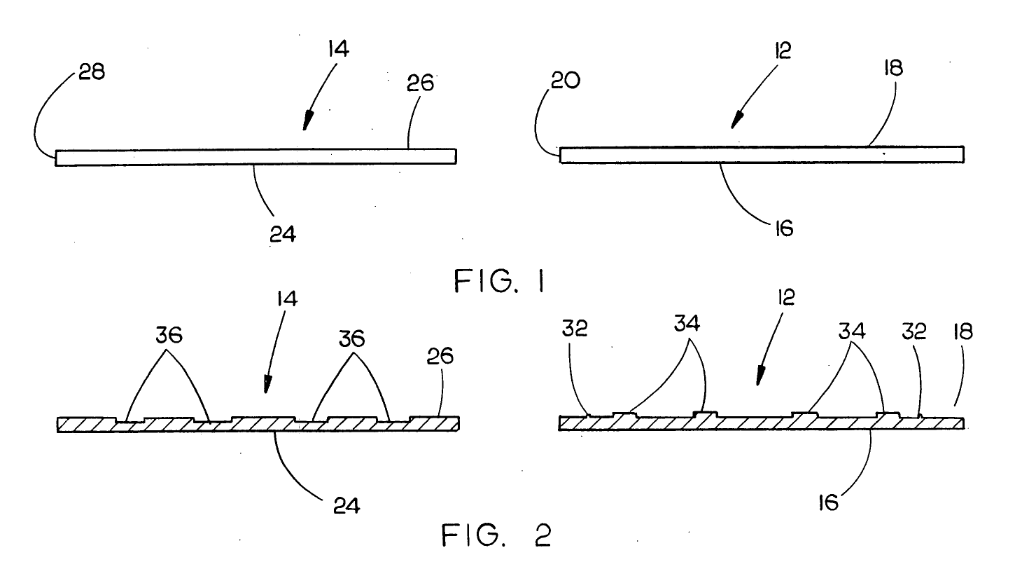

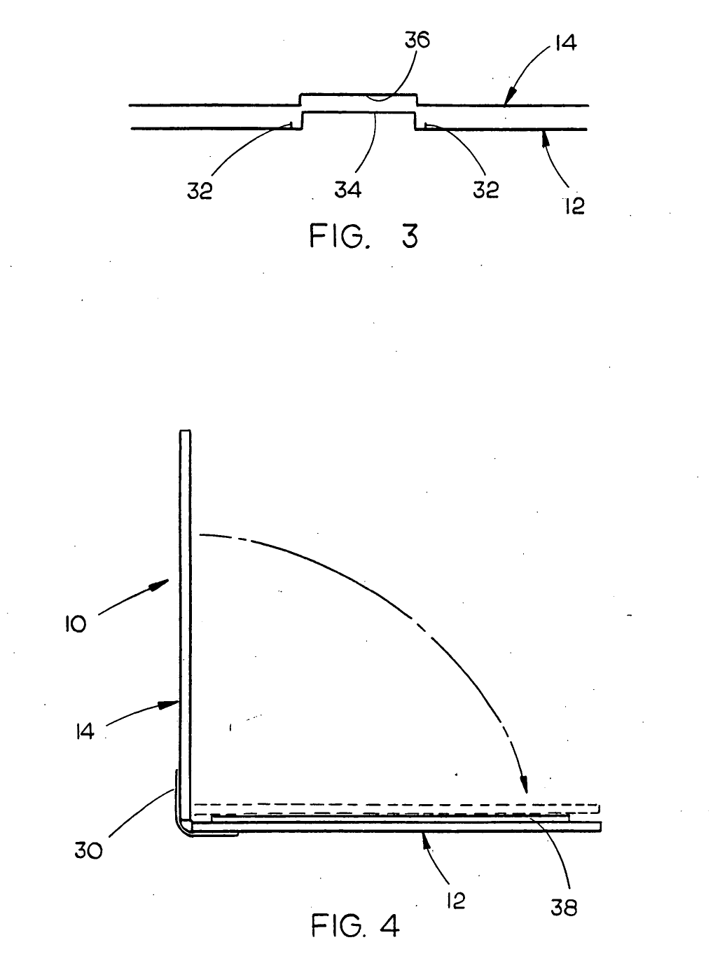

### DETAILED DESCRIPTION OF THE INVENTION

The numeral 10 refers to the die cutting and embossing die plate assembly of this invention which includes a first die plate 12 and a second die plate 14 which are generally square-shaped, rectangular-shaped, or any shape for that matter. Die plate 12 is referred to as the male die plate while plate 14 is referred to as the female die plate. Die plates 12 and 14 are preferably comprised of a thin steel material. Although the die plates 12 and 14 are preferably comprised of a thin steel material, one or more of the die plates 12 and 14 could be comprised of a plastic material or derivative thereof. In such a case, the lands and recesses would be molded.

For purposes of description, first die plate 12 will be described as having a first side 16, a second side 18 and a hinge edge 20. Preferably, first side 16 of die plate 12 is substantially flat in nature. Second die plate 14 will be described as having a first side 24, second side 26 and hinge edge 28. Preferably, the first side 24 of die plate 14 is substantially flat in nature. FIG. 1 illustrates the plates 12 and 14 prior to being chemically etched, chemically milled or mechanically etched.

The second side 18 of die plate 12 has a cutting land 32 projecting therefrom which will have a configuration such as to define the shape of the die cut which is to be separated from paper stock or card stock. Also, second side 18 of die plate 12 is provided with one or more embossing lands 34 projecting therefrom within the cutting land 32. The cutting land 32 and the embossing land 34 are formed in side 18 of die plate 12 by chemical etching, chemical milling or mechanical etching processes to remove die plate material from side 18 except for the cutting land 32 and embossing land 34.

The second side 26 of die plate 14 has at least one recessed area 36 formed therein which is complementary in shape and design to the embossing lands 34 formed in the second side 26 of die plate 14. The recessed area or areas 36 in plate 14 are created by chemical etching, chemical milling or mechanical etching.

Hinge edges 20 and 28 are hingedly secured together by any convenient means such as by tape 30 or the like.

The hinge connection of the plates 12 and 14 ensures that the cutting land 32 will be properly positioned and ensures that the one or more embossing lands 34 will register with the recessed area or areas 36 in die plate 14 when die plate 14 is moved to its closed position, as illustrated by broken lines in FIG. 4.

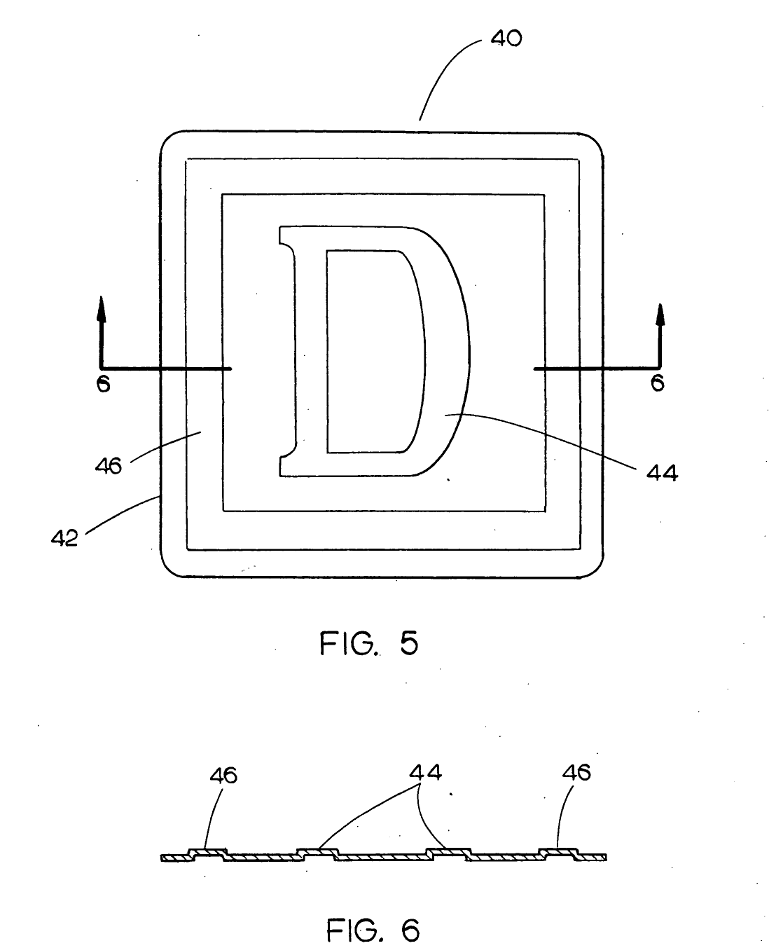

In use, a piece of paper stock or card stock 38 is placed between the die plates 12 and 14 (FIG. 4) with the die plates then being closed and passed through a die cutting machine so that the cutting land on the die plate 12 is forced through or substantially through the paper stock 38 and into engagement with the second die plate 14 in a “kissing” fashion, as known in the die cutting art, so that the cutting land will cut a die cut 40 from the paper stock or card stock in the desired shape which may be square, rectangular, ornamental, alphabet, numerals, etc. As the plate 14 is forced towards the plate 12 in the die cutting machine, the embossing land or lands 34 on plate 12 deform the paper stock 38 into the recessed area or areas 36 to emboss the die cut. Not only does the die plate assembly of this invention cut the design from the paper stock or card stock, but also embosses the die cut to further enhance the aesthetics of the die cut. The cutting and embossing of the die cut 40 is accomplished in a single process. The die cut 40 is illustrated in plan view in FIG. 5 and is illustrated in section in FIG. 6. The die cut 40 has a peripheral edge 42 which is created by the cutting land 32. The letter “D” is embossed in die cut 40 by embossing lands 34 to create the embossed letter “D” identified with the reference numeral 44. A border 46 is also embossed in die cut 40 by an embossing land 34.

Although a one-step method and means described above relates to the cutting and embossing of paper stock, card stock, etc., the die plates of this invention could also cut and deboss in a single step.

Thus it can be seen that the invention accomplishes at least all of its stated objectives.

1. A cutting and embossing die plate assembly, comprising:
a first die plate having a first side, and a second side
said second side of said first die plate having a cutting land projecting therefrom and
said second side of said first die plate also having at least one of an embossing land projecting therefrom and a recessed cavity configured therein within said cutting land; and
a second die plate having a first side, and a second side,
said second side of said second die plate having at least one of a recessed cavity formed therein and an embossing land projecting therefrom, said recessed cavity being complementary in size and shape to said at least one embossing land projecting from said second side of said first die plate and said embossing land being complementary in size and shape to the recessed cavity of said first plate,

2. The assembly of claim 1 wherein at least one of said second side of said first die plate and said second side of said second die plate is chemically etched to form said cutting land and said at least one embossing land.

3. The assembly of claim 1 wherein at least one of said second side of said first die plate and said second side of said second die plate is mechanically etched or milled to form said cutting land and said at least one embossing land.

4. The assembly of claim 1 wherein at least one of said second side of said first die plate and said second side of said second die plate is chemically milled to form said cutting land and said at least one embossing land.

5. The assembly of claim 1 wherein said recessed cavity is created by chemically etching at least one of said second side of said first die plate and said second side of said second die plate.

6. The assembly of claim 1 wherein said recessed cavity is created by chemically milling at least one of said second side of said first die plate and said second side of said second die plate.

7. The assembly of claim 1 wherein said recessed cavity is created by mechanically etching or milling at least one of said second side of said first die plate and said second side of said second die plate.

8. The assembly of claim 1 wherein said embossing land creates a letter of the alphabet in the die cut.

9. The assembly of claim 8 wherein a second embossing land projects from at least one of said second side of said first die plate and said second side of said second die plate to form an embossed border in the die cut.

10. The assembly of claim 1 wherein said cutting land creates a die cut having the shape of an ornamental object.

11. The assembly of claim 1 wherein said embossing land creates the shape of an ornamental object.

12. The method of cutting and embossing a die cut in a single step, comprising:
providing a first die plate having a first side, a second side,
said second side of said first die plate having a cutting land projecting therefrom which is adapted to cut through or substantially through a piece of paper stock or card stock to create a die cut which is separable from the piece of paper stock or card stock;
said second side of said first die plate also having at least one embossing land projecting therefrom within said cutting land for embossing the die cut; providing a second die plate having a first side, a second side,
said second side of said second die plate having at least one recessed cavity formed therein which is complementary in size and shape to said at least one embossing land projecting from said second side of said first die plate;
positioning a paper member on either said second side of said first die plate or on said second side of said second die plate; and
moving said second sides of said first and second die plates towards one another to cause said cutting land to cut through or to substantially cut through the paper member to form a die cut and to cause the embossing land or lands to emboss the die cut.

13. The method of claim 12 wherein said embossing land creates a letter of the alphabet in the die cut.

14. The method of claim 12 wherein said cutting land creates a die cut having the shape of an ornamental object.

15. The method of claim 12 wherein said embossing land creates the shape of an ornamental object.

16. The method for creating a die cut, comprising the following steps:
placing a paper member between first and second die plates; moving first and second die plates towards one another to simultaneously cut a die cut from the paper member and to emboss the die cut.

17. A die plate assembly, comprising:
a first die plate having first and second sides;
a second die plate having first and second sides;
said second side of said first die plate having a cutting land projecting thereform and having an embossing land projecting therefrom within said cutting land;
said second side of said second die plate having an embossing recess formed therein which registers with said embossing land.

18. A die plate assembly, comprising:
a first die plate having first and second sides;
a second die plate having first and second sides;
said second sides of said first and second die plates having cutting and debossing lands and at least one debossing recess formed therein which registers with the debossing land on the other die plate.

19. The assembly of claim 1, further comprising a hinge connecting said first die plate and said second die plate and configured to align the complementary projecting and recessed portions of said first die plate and said second die plate into contact during operation.
